(19) United States
(12) Patent Application Publication
(10) Pub. No.: US 2026/0364852 A1
(43) Pub. Date: Nov. 19, 2026

(54) SLICING MACHINE, SLICING CELLULAR MANUFACTURING LINE AND CONTROL METHOD THEREOF

(71) Applicant: QINGDAO GAOCE TECHNOLOGY CO., LTD., Qingdao (CN)

(72) Inventors: Chenchen CUI, Qingdao (CN); Guangzhong WU, Qingdao (CN); Ning TENG, Qingdao (CN); Pengfei LIU, Qingdao (CN); Guochao YU, Qingdao (CN); Xujun LIU, Qingdao (CN); Weixiao ZHANG, Qingdao (CN); Rui TIAN, Qingdao (CN)

(21) Appl. No.: 19/480,319

(22) PCT Filed: Jun. 28, 2024
(86) PCT No.: PCT/CN2024/102224

§ 371 Date: Oct. 30, 2025

(30) Foreign Application Priority Data
Jun. 30, 2023 (CN) 202310800848.1
Jun. 30, 2023 (CN) 202321710430.3
Jun. 30, 2023 (CN) 202321720263.0
Jun. 30, 2023 (CN) 202321720265.X
Aug. 31, 2023 (CN) 202311115590.8
Aug. 31, 2023 (CN) 202311115613.5
Aug. 31, 2023 (CN) 202311115628.1
Aug. 31, 2023 (CN) 202311121246.X
Aug. 31, 2023 (CN) 202311121279.4
Aug. 31, 2023 (CN) 202311121292.X
Aug. 31, 2023 (CN) 202311121302.X

(51) Int. Cl. B28D 5/04; B28D 5/00

(52) U.S. Cl. CPC B28D 5/045; B28D 5/0064; B28D 5/0076; B28D 5/0082

(57) ABSTRACT

A slicing cellular manufacturing line, comprising a manufacturing line main body (1). The manufacturing line main body (1) is provided with a plurality of slicing machines (5), a transfer mechanism and a connection tool (4). Each slicing machine (5) comprises a slicing machine main body (51), a liquid path portion and an electric control portion, the slicing machine main body (51) being provided with a cutting chamber (52), the liquid path portion and the electric control portion being arranged on the outer side of the cutting chamber (52), and the configuration mode of the liquid path portion and the electric control portion enabling the slicing machine (52) to be provided with a clearance space, so that a workpiece can pass through the clearance space to achieve a feeding operation and/or a discharging operation. The transfer mechanism comprises a ceiling rail robot (31), a first transfer table and a second transfer table. The connection tool (4) comprises a first movable portion (41) and a carrying portion; the first movable portion (41) can move in the direction toward/away from the cutting chamber (52) of each slicing machine (5), and the first movable portion (41) is provided with at least one connection structure capable of fixedly connecting the first movable portion (41) to a workpiece; and the carrying portion can carry the workpiece. The slicing cellular manufacturing line, by means of multi-machine simultaneous slicing, satisfies the requirement for larger-scale slicing manufacturing. The present disclosure also relates to a control method of the slicing cellular manufacturing line.

### TECHNICAL FIELD

The present disclosure relates to the technical field of wire cutting, and specifically provides a slicer, a slicing production line, and a control method therefor.

### TECHNICAL BACKGROUND

Taking the workpiece to be processed (hard and brittle material) being a silicon rod as an example, a device for processing it usually includes a cutting machine that cuts the rod material (round rod) according to length specifications, a square cutter that cuts a round rod with a certain length into a square rod, a grinding machine that grinds (a grinding surface and chamfer of) the square rod (usually including rough grinding and fine grinding), and a slicer that slices the square rod that meets the precision standard after grinding. The working principle of the slicer is described as follows: after bonding the square rod to a crystal holder, the square rod is sliced by wire saw cutting through a wire network of the cutting machine (the silicon rod is fed toward the wire network, and the wire network reciprocates between adjacent cutting rollers) to produce silicon wafers. Correspondingly, each complete slicing operation of the wire network is called one cutting operation of the slicer.

Taking the slicing operation as an example, the slicing operations of existing slicers are concentrated near the slicing station, and each cutting operation is a single machine operation for a single silicon rod. Since each cutting operation usually includes dozens of operation steps and is usually completed by one to two operators, this processing method often has the following problems: the operation of the slicer requires high professionalism and proficiency for the operators, and the large number of steps makes it easy for the operators to make mistakes; once the operator makes a mistake, it may lead to different degrees of cutting abnormalities.

Taking the photovoltaic industry as an example, which is one of the application fields of silicon wafers, with the rapid development of the photovoltaic industry, there is inevitably a demand for continuous production expansion in the above silicon wafer processing chain including the slicing operation. As mentioned earlier, this will lead to a continuous increase in the shortage of operators who are already understaffed. Therefore, single machine products (slicers) corresponding to single machine operations are gradually unable to meet market demand. In view of this, after conducting sufficient research and analysis on the operations of slicers, the inventor has proposed a cellular structure framework that can achieve simultaneous operations of multiple slicers. Accordingly, there is a need for a group control logic for multiple slicers to ensure the operational reliability of the cellular structure framework.

### SUMMARY

The present disclosure aims to provide a slicer, a corresponding production line capable of achieving slicing cellular operations completed by multiple slicers, and a group control logic for the production line.

The present disclosure provides a control method for a slicing cellular production line, in which the slicing cellular production line includes a production line body, which is provided with a feeding assembly and a discharging assembly, and includes a transfer mechanism, a transition tooling and multiple slicers; the transfer mechanism includes a ceiling rail robot, a first transfer platform arranged in a feeding area corresponding to the feeding assembly, and a second transfer platform arranged in a discharging area corresponding to the discharging assembly; the ceiling rail robot can move between the feeding area corresponding to the feeding assembly and the discharging area corresponding to the discharging assembly, and can move within the feeding area and/or the discharging area; the control method includes: obtaining the current slicing task; selecting at least one slicer from the multiple slicers to perform the current slicing task, based on the current slicing task; making the ceiling rail robot drive the first transfer platform and/or the second transfer platform to operate, so that workpieces placed on the first transfer platform and/or the second transfer platform are delivered to/removed from a position that matches the at least one slicer; and coordinating the operation of the transition tooling and the ceiling rail robot so that the workpieces are delivered to/removed from a cutting area of the slicer. Through such an arrangement, it is possible to select a suitable single machine to complete the current slicing task in a case where the production line includes multiple single slicers. Based on this, it is expected to meet the demand for larger scale slicing production by simultaneously slicing through multiple machines.

### BRIEF DESCRIPTION OF DRAWINGS

With reference to the accompanying drawings, preferred embodiments of the present disclosure will be described below using an example in which the workpiece is a silicon rod (hereinafter referred to as silicon rod, including a silicon rod to be processed that contains a crystal holder and a processed silicon wafer that contains a crystal holder) and the transfer mechanism is a combination mechanism including a ceiling rail robot.

For example, a first case mainly includes a ceiling rail robot and two transfer platforms (referred to as first transfer platform and second transfer platform respectively) arranged in the feeding area and the discharging area; the obvious advantage of the ceiling rail robot is that it can free up ground space well enough to place items and for them to pass through. However, there may also be corresponding disadvantages such as the device being difficult to maintain since it is arranged at a high place.

For example, a second case mainly includes a ceiling rail robot, two transfer platforms arranged in the feeding area and the discharging area, and an opening and closing assembly walking on a truss in the discharging area; the obvious advantage of the ceiling rail robot is that it can free up ground space well enough to place items and for them to pass through.

For example, a third case mainly includes a ceiling rail robot, two transfer platforms arranged in the feeding area and the discharging area, and opening and closing assemblies (truss robotic arms) walking on two trusses in the feeding area and the discharging area; the obvious advantage of the ceiling rail robot is that it can free up ground space well enough to place items and for them to pass through. However, there may also be corresponding disadvantages such as the device being difficult to maintain since it is arranged at a high place.

In the drawings:

FIG. 1 shows a first schematic view of the structure of a slicing cellular production line according to an embodiment of the present disclosure, illustrating a ceiling rail robot in a transfer mechanism and a single slicer in the slicing cellular production line;

FIG. 2 shows a first schematic view of the structure of a transition tooling in the slicing cellular production line according to an embodiment of the present disclosure;

FIG. 3 shows a second schematic view of the structure of the transition tooling in the slicing cellular production line according to an embodiment of the present disclosure;

FIG. 4 shows a third schematic view of the structure of the transition tooling in the slicing cellular production line according to an embodiment of the present disclosure;

FIG. 5 shows a first schematic view illustrating the status of the feeding operation on a single slicer performed by the transition tooling in the slicing cellular production line according to an embodiment of the present disclosure (with the ceiling rail robot in place);

FIG. 6 shows a second schematic view illustrating the status of the feeding operation on a single slicer performed by the transition tooling in the slicing cellular production line according to an embodiment of the present disclosure (an extended end at the rear part of the transition tooling hooks a handle at a tail end of the crystal holder);

FIG. 7 shows a third schematic view illustrating the status of the feeding operation on a single slicer performed by the transition tooling in the slicing cellular production line according to an embodiment of the present disclosure (the entire material exits the interior of the jig and is transitioned to an internal guide rail of the cutting chamber);

FIG. 8 shows a fourth schematic view illustrating the status of the feeding operation on a single slicer performed by the transition tooling in the slicing cellular production line according to an embodiment of the present disclosure (a first movable part of the transition tooling extends out and hooks the handle at the tail end of the crystal holder);

FIG. 9 shows a fifth schematic view illustrating the status of the feeding operation on a single slicer performed by the transition tooling in the slicing cellular production line according to an embodiment of the present disclosure (the entire material is pushed into the cutting chamber);

FIG. 10 shows a first schematic view illustrating the status of the discharging operation on a single slicer performed by the transition tooling in the slicing cellular production line according to an embodiment of the present disclosure (with the ceiling rail robot in place);

FIG. 11 shows a second schematic view illustrating the status of the discharging operation on a single slicer performed by the transition tooling in the slicing cellular production line according to an embodiment of the present disclosure (the first movable part of the transition tooling extends out and hooks the handle at the tail end of the crystal holder);

FIG. 12 shows a third schematic view illustrating the status of the discharging operation on a single slicer performed by the transition tooling in the slicing cellular production line according to an embodiment of the present disclosure (the entire material is pulled out of the cutting chamber);

FIG. 13 shows a fourth schematic view illustrating the status of the discharging operation on a single slicer performed by the transition tooling in the slicing cellular production line according to an embodiment of the present disclosure (the first movable part of the transition tooling extends out again, and the extended end at the rear part thereof hooks the handle at the tail end of the crystal holder);

FIG. 14 shows a fifth schematic view illustrating the status of the discharging operation on a single slicer performed by the transition tooling in the slicing cellular production line according to an embodiment of the present disclosure (the entire material is pulled into the jig);

FIG. 15 shows a first schematic view of the structure of a single slicer in a slicing cellular production line according to an embodiment of the present disclosure;

FIG. 16 shows a second schematic view of the structure of the single slicer in the slicing cellular production line according to an embodiment of the present disclosure;

FIG. 17 shows a third schematic view of the structure of the single slicer in the slicing cellular production line according to an embodiment of the present disclosure;

FIG. 18 shows a fourth schematic view of the structure of the single slicer in the slicing cellular production line according to an embodiment of the present disclosure;

FIG. 19 shows a second schematic view of the structure of the slicing cellular production line according to an embodiment of the present disclosure, which illustrates an opening and closing assembly in the transfer mechanism but does not illustrate the single slicer in the slicing cellular production line;

FIG. 20(a)-(d) show schematic flowcharts of the control methods for slicing cellular production lines according to four embodiments of the present disclosure; and

FIG. 21 shows a specific schematic flowchart of the control method for a slicing cellular production line according to an embodiment of the present disclosure.

### DETAILED DESCRIPTION OF THE EMBODIMENTS

Preferred embodiments of the present disclosure will be described below with reference to the accompanying drawings. It should be understood by those skilled in the art that these embodiments are only used to explain the technical principles of the present disclosure, and are not intended to limit the scope of protection of the present disclosure. For example, in addition to the combination mechanism including the ceiling rail robot, the present disclosure may also include but is not limited to mechanisms such as ground rail robots, truss robotic arms, RGVs, AGVs, etc., or combination mechanisms including related mechanisms. For example, the transfer mechanism includes a first truss robotic arm walking on a first truss between the feeding area and the discharging area, and a second truss robotic arm walking on a second truss within the feeding area and/or the discharging area (for example, the walking direction of the first truss robotic arm is substantially perpendicular to that of the second truss robotic arm).

It should be noted that in the description of the present disclosure, directional or positional relationships indicated by terms such as “center”, “upper”, “lower”, “left”, “right”, “vertical”, “horizontal”, “inner” and “outer” are based on the directional or positional relationships shown in the drawings. They are merely used for the convenience of description, and do not indicate or imply that the device or element involved must have a specific orientation, or be configured or operated in a specific orientation, and therefore they should not be construed as limiting the present disclosure. In addition, terms “first” and “second” are used for descriptive purpose only, and should not be construed as indicating or implying relative importance.

In addition, it should also be noted that in the description of the present disclosure, unless otherwise clearly specified and defined, terms “install”, “arrange” and “connect” should be understood in a broad sense; for example, the connection may be a fixed connection, or a detachable connection, or an integral connection; it may be a direct connection, or an indirect connection implemented through an intermediate medium, or it may be an internal communication between two elements. For those skilled in the art, the specific meaning of the above terms in the present disclosure can be understood according to specific situations.

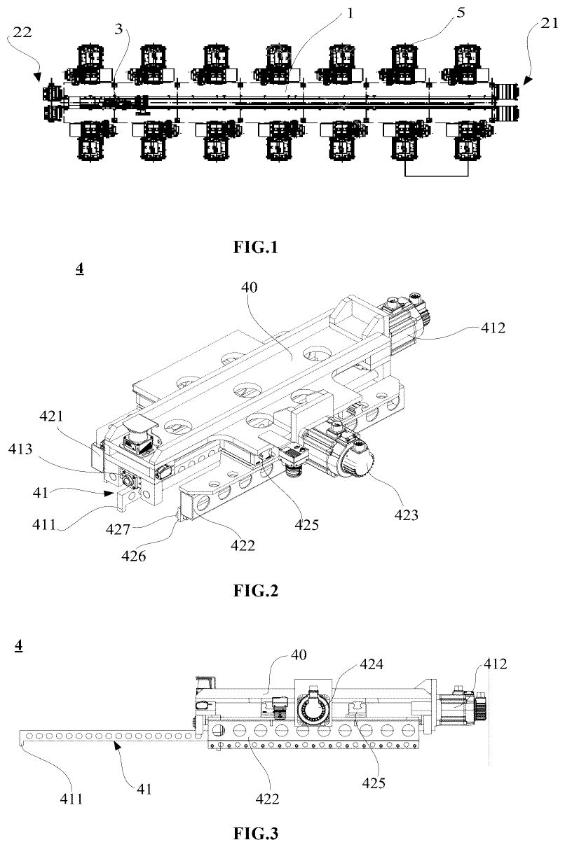

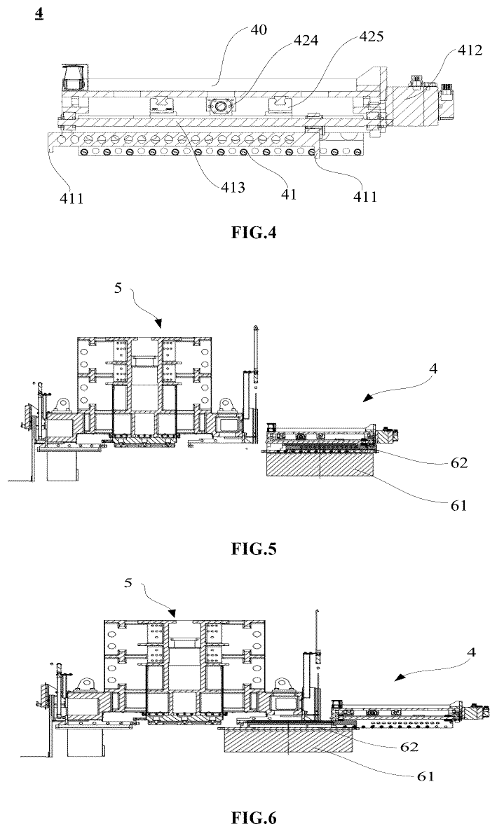

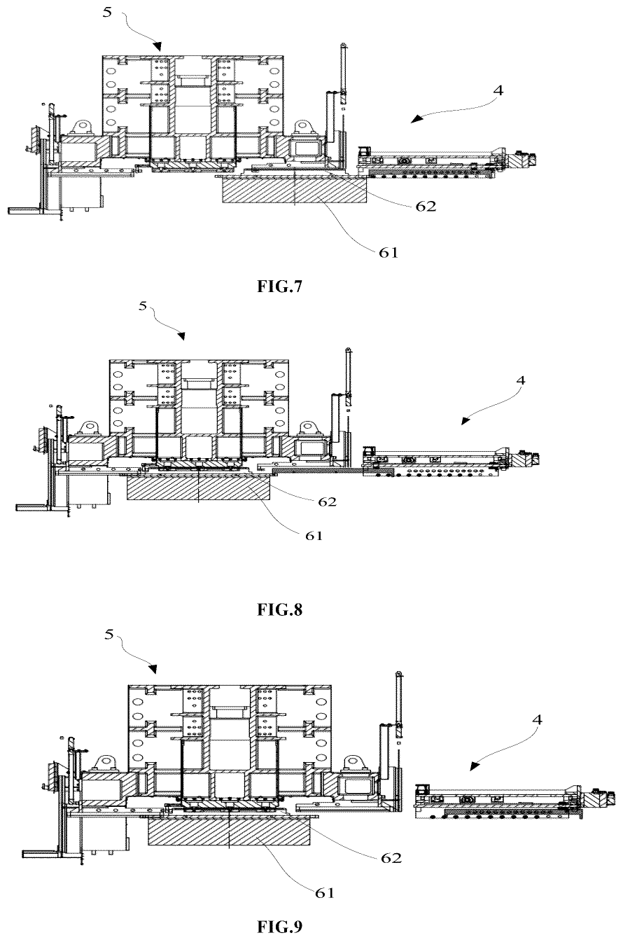

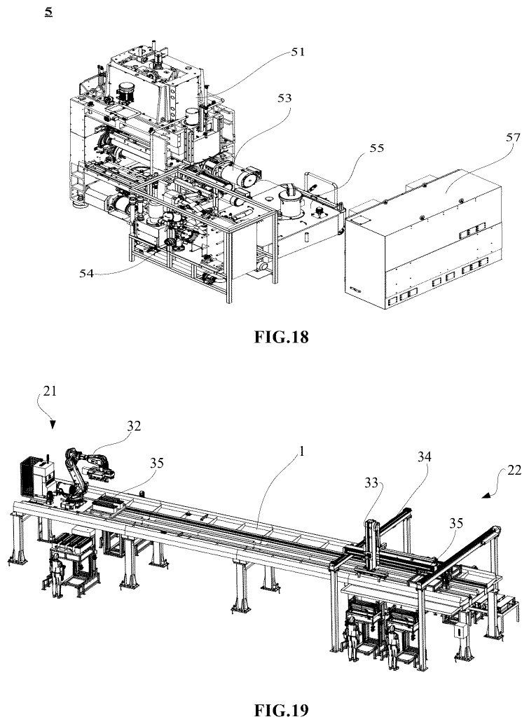

In addition, in order to better illustrate the present disclosure, numerous specific details are provided in the following specific embodiments. It should be understood by those skilled in the art that the present disclosure can also be implemented without certain specific details. In some examples, the principles of slicers and transfer mechanisms including ceiling rail robots and the like, which are well known to those skilled in the art, are not described in detail, with the purpose of highlighting the main concepts of the present disclosure. In the following, the present disclosure will be explained with reference to some or all of FIGS. 1 to 21.

As a device form of wire cutting machine, the slicer is mainly used to cut silicon rods (usually referred to as square rods) that meet the grinding precision standard using a wire network composed of a cutting wire (such as a diamond wire, etc.) to obtain silicon wafers. Under normal circumstances, the slicing operation is carried out as follows: after completing the rod bonding process in the adhesive workshop (bonding the square rod to be sliced to the crystal holder), the crystal holder is fixed to a feeding mechanism. During the reciprocating motion of the wire network between the cutting main rollers of the cutting mechanism, the feeding mechanism drives the silicon rod to approach the wire network, so that the square rod can be sliced by the wire network in a way of wire saw cutting. For example, the slicer includes a slicer body, the slicer body is formed with a cutting chamber, and an operation door is provided on each of left and right sides of the cutting chamber respectively. The cutting mechanism is arranged inside the cutting chamber. In this example, the cutting mechanism composed of multiple cutting main rollers forms a structure of a single station that can slice and process a silicon rod in a single operation.

In a possible implementation, the present disclosure provides a control method for a slicing cellular production line, which is applied to a slicing production line capable of achieving multi-machine automation production. The production line mainly includes a production line body 1 which, for example, may include but is not limited to necessary workbenches, ends that allow for manual intervention, parts that require manual operation, control ends configured at the operation site, collection ends that can collect on-site operations (such as visual signals, sound signals, etc.), a central control end that can analyze and control on-site slicing operations, and a reminder end that can issue reminder information such as voice broadcasts and alarms when necessary. The production line body is provided with multiple slicers 5 (single machines). Based on this, it is expected that multiple slicers can simultaneously perform slicing operations on the silicon rods to be processed (square rods obtained by grinding), or some of them are selected to perform slicing operations on the silicon rods. If multiple single machines are configured in a removable manner on the production line, the scale of the production line can be flexibly adjusted, and the single machines can be replaced or repaired after removal. In addition, the structural forms of the multiple single machines, the way they perform slicing operations, and the way they are configured in the production line body can be the same or different. For example, the production line body includes multiple areas, where a single machine in a certain area is mainly used to process silicon wafers with more stringent requirements, so the single machine corresponding to this area has better processing precision.

In a possible implementation, the production line body is provided with a feeding assembly and a discharging assembly, where the feeding assembly is transitioned to the adhesive workshop or adhesive area; for example, the silicon rods (bonded to the crystal holder) from the curing warehouse of the adhesive workshop can be transferred to a feeding area 21 corresponding to the feeding assembly through manual and/or automatic operation, such as manually transferring a cart carrying the silicon rods to the feeding area. The discharging assembly is transitioned to a debonding workshop or debonding area. The debonding workshop mainly debonds the silicon rods (in the form of multiple silicon wafers) that have been bonded to the crystal holder and have completed the slicing operation. Similar to the transition between the adhesive workshop or adhesive area and the feeding operation mentioned above, the silicon wafers in a discharging area 22 corresponding to the discharging assembly can also be transferred to the debonding workshop or debonding area through manual and/or automatic operations. For example, a cart carrying the silicon rods can be manually transferred to the debonding workshop or debonding area. For example, the feeding assembly and/or the discharging assembly usually include feeding/discharging carts or feeding/discharging racks, etc.

In a possible implementation, the aforementioned multiple single machines share one feeding assembly and one discharging assembly, and similar feeding and discharging control logics are adopted for the single machines. Obviously, the structure of the feeding/discharging assemblies can also be adjusted according to actual needs, including but not limited to: configuring multiple feeding assemblies and discharging assemblies for multiple slicers, such as configuring one feeding assembly and one discharging assembly for one or more single machines according to orientation, priority, product model, and properties of the workpieces to be processed (such as the uniqueness or importance of a batch of products), etc. ; for example, one feeding assembly and one discharging assembly are configured for multiple single machines in the same row, and separate feeding assembly and discharging assembly are configured for a certain single machine; multiple single machines share one feeding assembly and one discharging assembly, and separate feeding and discharging control logics are configured for a certain one or more single machines (for example, also according to the aforementioned orientation, priority, product model, and properties of the workpieces to be processed, etc.).

Taking multiple single machines sharing a set of feeding assemblies and a set of discharging assemblies as an example, the production line includes a transfer mechanism. The transfer mechanism is mainly used to achieve the transfer of the silicon rods to be sliced and the cut silicon wafers between the feeding assembly, the slicer, and the discharging assembly, as well as inside the feeding assembly and the discharging assembly respectively, e.g., including transferring the silicon rods to be sliced between the feeding assembly and the slicer (feeding operation), transferring the cut silicon wafers between the slicer and the discharging assembly (discharging operation), performing corresponding operations inside the feeding/discharging assembly, and performing operations such as picking and placing material between the feeding/discharging assembly and within the area between the two, and other transitioning operations.

In a possible implementation, the transfer mechanism includes a robotic arm/robot capable of walking at least in the direction between the feeding assembly, the discharging assembly, and different slicers. For example, the robotic arm can walk between the feeding assembly and the discharging assembly (e.g., referred to as the length direction), walk in the direction of moving in/out of the cutting area of the single machine (e.g., referred to as the width direction), and move in the vertical direction (e.g., referred to as the longitudinal direction) by means of trusses, ceiling rails, ground rails, and other structures. For example, it is possible to calculate the reasonable number of single machines that need to be configured and the layout between multiple single machines based on the corresponding group control logic cycle time, in order to achieve the feeding and discharging operations of silicon rods for single machine (moving in/out of the cutting area of the single machine) and production line (entering the feeding area of the production line or leaving the discharging area of the production line) through the corresponding walking of the robotic arm. In this example, the robotic arm of the transfer mechanism includes a ceiling rail robot 31 and an opening and closing assembly 33 which is configured in the discharging area and serves a discharging transfer mechanism. For example, the opening and closing assembly 33 can walk along the width direction of the production line body 1 on a truss 34. The cooperation between the ceiling rail robot and the ceiling rail configured on the production line body is used to achieve the walking requirements along the length direction (the part between the feeding assembly and the discharging assembly), the width direction (moving toward/away from the cutting chamber of the slicer) and the longitudinal direction (to create constraints or release constraints between the transition tooling and the crystal holder) corresponding to the slicing cellular production line. For example, a transfer platform 35 capable of placing one or more silicon rods is provided in the feeding area and the discharging area, respectively. The ceiling rail robot can take the silicon rods from the transfer platform and further deliver them to the slicers for slicing operations. For example, after the ceiling rail robot has delivered the sliced silicon wafers to the transfer platform corresponding to the discharging area, the opening and closing assembly can take the silicon wafers from the transfer platform and further transfer them to the debonding workshop or debonding area. Preferably, the transfer platform itself can also move, such as through the cooperation of the transfer platform and the ceiling rail robot/truss robotic arm to complete the transfer task while further saving cycle time. This may include but is not limited to the following cases.

### First Case

Neither the feeding area nor the discharging area is provided with truss or opening and closing assembly that walks on the truss. The transfer mechanism only includes a ceiling rail and a ceiling rail robot configured on the ceiling rail. Corresponding to the transfer platform in the feeding area, both the feeding area and the discharging area are provided with transfer platforms, and the transfer platforms corresponding to the feeding/discharging areas can move together with the ceiling rail robot. In this way, the operation corresponding to the slicing production line should include: the ceiling rail robot carrying the transition tooling picks up the silicon rod containing the crystal holder from the feeding assembly, and places the silicon rod onto the transfer platform corresponding to the feeding area; the ceiling rail robot and the transfer platform corresponding to the feeding area move together to the slicer (single machine) that is performing the current slicing operation; the ceiling rail robot picks up one of the silicon rods (the workpiece to be processed in this slicing operation) from the transfer platform corresponding to the feeding area, which has moved to the single machine, and feeds it into the cutting chamber of the slicer. After the slicer completes this slicing operation, the ceiling rail robot will place the silicon wafer (cut material) containing the crystal holder and discharged from the corresponding slicer onto the transfer platform corresponding to the discharging area (the transfer platform corresponding to the discharging area has been pre-positioned at the position of the slicer for which discharging is required by moving the transfer platform together with the ceiling rail robot), and transfer the cut material to the discharging area by moving the transfer platform corresponding to the discharging area and the ceiling rail robot together. Afterwards, the ceiling rail robot carrying the transition tooling further transfers the cut material from the transfer platform corresponding to the discharging area to the discharging assembly.

The slicing cellular production line corresponding to the first case roughly includes the following four steps for the process of any single slicing operation:
a material retrieval step which specifically includes: the ceiling rail robot carrying the transition tooling retrieves the material from the feeding assembly, and places the material (such as the silicon rod bonded to the crystal holder) onto the transfer platform corresponding to the feeding area;
a feeding step which specifically includes: the ceiling rail robot and the transfer platform corresponding to the feeding area move together to the feeding position corresponding to the slicer that has completed the current slicing operation, and complete the feeding operation of delivering the material (such as the silicon rod adhered to the crystal holder) to the cutting area of the slicer;
a discharging step which specifically includes: the ceiling rail robot carrying the transition tooling moves to the discharging position corresponding to the slicer, and takes out the sliced silicon rod from the slicer; and
a material release step which specifically includes: the ceiling rail robot and the transfer platform corresponding to the discharging area move together to transport the cut material (such as the sliced silicon rod) and place it onto the discharging assembly.

Second case

The truss and the opening and closing assembly walking on the truss are only provided in the discharging area, and both the feeding area and the discharging area are provided with transfer platforms. The transfer platform corresponding to the feeding area can move together with the ceiling rail robot, and the transfer platform corresponding to the discharging area can move autonomously (alternatively, the truss and the opening and closing assembly walking on the truss are only provided in the feeding area, and the transfer platform corresponding to the discharging area moves together with the ceiling rail robot. It can be understood that those skilled in the art can choose appropriate motion paths, motion modes, and mechanisms used to achieve motion according to actual needs, such as walking wheels that can walk freely configured for the transfer platform corresponding to the discharging area, tracks configured for the transfer platform to travel, etc.) and therefore can cooperate with the truss and the opening and closing assembly configured in the discharging area to complete the corresponding transfer tasks within the discharging area. In this way, the operation corresponding to the slicing production line should include: the ceiling rail robot carrying the transition tooling picks up the silicon rod containing the crystal holder from the feeding assembly, and places the silicon rod onto the transfer platform corresponding to the feeding area; the ceiling rail robot and the transfer platform corresponding to the feeding area move together to the slicer (single machine) that is performing the current slicing operation; the ceiling rail robot picks up one of the silicon rods (the workpiece to be processed in this slicing operation) from the transfer platform corresponding to the feeding area, and feeds it into the cutting chamber of the slicer. Since the transfer platform corresponding to the feeding area and the ceiling rail robot can move together, it is possible to place several more silicon rods at the feeding position (multiple silicon rods can be placed on the transfer platform corresponding to the feeding area), without the need to include the step of retrieving materials in every slicing operation, which is expected to save the cycle time of material retrieval and feeding. After the slicer completes this slicing operation, the ceiling rail robot will place the silicon wafer (cut material) containing the crystal holder and discharged from the corresponding slicer onto the transfer platform corresponding to the discharging area (the transfer platform corresponding to the discharging area has moved in advance to the position of the slicer for which discharging is required through autonomous motion). For example, multiple cut materials can be placed on the transfer platform corresponding to the discharging area, and then the transfer platform corresponding to the discharging area will reach the discharging position through autonomous motion; afterwards, the cut materials will be placed from the transfer platform corresponding to the discharging area to the discharging assembly through the opening and closing assembly walking on the truss.

The slicing cellular production line corresponding to the second case roughly includes the following four steps for the process of any single slicing operation:
a material retrieval step which specifically includes: the ceiling rail robot carrying the transition tooling retrieves the material from the feeding assembly, and places the material (such as the silicon rod bonded to the crystal holder) onto the transfer platform corresponding to the feeding area;
a feeding step which specifically includes: the ceiling rail robot and the transfer platform corresponding to the feeding area move together to the position corresponding to the slicer that has completed the current slicing operation, and complete the feeding operation of delivering the material (such as the silicon rod bonded to the crystal holder) to the cutting area of the slicer;
a discharging step which specifically includes: the ceiling rail robot carrying the transition tooling moves to the discharging position corresponding to the slicer, and takes out the sliced silicon rod from the slicer (or after the sliced silicon rod is taken out, the transfer platform corresponding to the discharging area autonomously moves to the discharging area); and
a material release step which specifically includes: the opening and closing assembly moves along the truss to transport the cut material (such as the sliced silicon rod) on the transfer platform corresponding to the discharging area and place it onto the discharging assembly.

### Third Case

In addition to providing the truss and the opening and closing assembly that walks on the truss in the discharging area, the truss and the opening and closing assembly that walks on the truss are also provided in the feeding area (it can be understood that the structures and arrangements of the trusses and the opening and closing assemblies corresponding to the feeding/discharging areas may be the same or different). In addition to this, the difference between the third case and the second case also lies in that the ceiling rail robot and the transfer platform corresponding to the feeding area do not move synchronously. In this way, the transfer platform corresponding to the feeding area can cooperate with the truss and the opening and closing assembly provided in the feeding area to complete the transfer task in the feeding area. That is, in this example, the transfer platforms corresponding to the feeding and discharging areas both can move autonomously to achieve movements that are compatible with the group control logic. In this way, the operation corresponding to the slicing production line should include: the opening and closing assembly corresponding to the feeding area transfers the silicon rod from the feeding assembly to the transfer platform corresponding to the feeding area. At this time, multiple silicon rods can be placed on the transfer platform corresponding to the feeding area to save the cycle time. The transfer platform corresponding to the feeding area reaches the position of the slicer (single machine) corresponding to the current slicing operation through autonomous movement. The ceiling rail robot also moves independently from the transfer platform corresponding to the feeding area to the position of the slicer that is performing the current slicing operation. The ceiling rail robot lifts one of the multiple silicon rods placed on the transfer platform corresponding to the feeding area into the cutting chamber of the slicer. The subsequent movements are similar to those in the second case mentioned above, and will not be described repeatedly herein.

The slicing cellular production line corresponding to the third case roughly includes the following four steps for the process of any single slicing operation:
a material retrieval step which specifically includes: the opening and closing assembly corresponding to the feeding area retrieves the material from the feeding assembly by walking along the truss, and places the material (such as the silicon rod bonded to the crystal holder) onto the transfer platform corresponding to the feeding area;
a feeding step which specifically includes: the transfer platform corresponding to the feeding area reaches the position of the slicer that completes the current slicing operation through autonomous movement, and the ceiling rail robot carrying the transition tooling also reaches the position of the slicer that completes the current slicing operation by moving relatively independent from the transfer platform corresponding to the feeding area to complete the feeding operation of delivering the material (such as the silicon rod bonded to the crystal holder) to the cutting area of the slicer;
a discharging step which specifically includes: the ceiling rail robot carrying the transition tooling moves to the discharging position corresponding to the slicer, and takes out the sliced silicon rod from the slicer (or after the sliced silicon rod is taken out, the transfer platform corresponding to the discharging area autonomously moves to the discharging area); and
a material release step which specifically includes: the opening and closing assembly corresponding to the discharging area moves along the truss to transport the cut material (such as the sliced silicon rod) on the transfer platform corresponding to the discharging area and place it onto the discharging assembly.

It can be understood that the above-mentioned ceiling rail robot 31 and opening and closing assembly 33 are only exemplary description of the transfer mechanisms. Those skilled in the art can flexibly adjust the types, number, and corresponding transfer paths of the transfer mechanisms included in this example according to the actual situation. For example, the feeding area is also provided with the opening and closing assembly that can walk on the truss, or two ceiling rail robots are included (one located between the feeding assembly and the discharging assembly, and the other located in the feeding area). For example, the transfer operation in the discharging area can also be completed by the ceiling rail robot. For example, the ceiling rail robot carrying the transition tooling moves to the position of the slicer for which discharging is required, takes out the sliced silicon rod (the silicon wafer containing the crystal holder) from the slicer, and directly places it onto the discharging assembly, or places it onto the discharging assembly via the transfer platform.

In addition, with further expansion of the scale of cellular production, there may be a form of multiple production line bodies. In this way, the truss arranged along the width direction of the production line body can be extended to allow multiple production line bodies to share one discharging transfer mechanism. For example, corresponding to the aforementioned second and third cases, the scale of the slicing cellular production line can be further expanded. Still taking the aforementioned transfer mechanism containing a ceiling rail robot as an example, the operation of the slicing cellular production line will include the operation shared by the opening and closing assemblies corresponding to the feeding/discharging areas when walking between different production line bodies. Correspondingly, the group control logic corresponding to the slicing cellular production line needs to consider the number of silicon rods to be processed, the device status of the single machine, the status of the ceiling rail robot, and the position/status of the opening and closing assembly to match the appropriate single machine and corresponding group control logic for the silicon rod that needs to be processed currently. Based on this, for a single production line body, through the cooperation between the ceiling rail robot, the transfer platform corresponding to the feeding area, and the opening and closing assembly corresponding to the feeding area (in a case where the feeding area is provided with the opening and closing assembly), the silicon rod to be processed is transported from the feeding assembly to a preset target position (for example, the target position can be flexibly determined based on the existing logic of the single machine or in combination with the logic of the slicing cellular production line) that can be transitioned with the single machine that completes the current slicing operation according to the control instructions of the group control logic. When the silicon rod arrives at the target location, the group control logic can reconfirm status information of the single machine that completes the current slicing operation according to the device management information and the like; for example, the status information includes but is not limited to in-operation, debugging, in-maintenance, fault handling, and standby. After the malfunction of the ceiling rail robot, the feeding operation for the current single machine can be achieved by replacing the ceiling rail robot with manual feeding from a front wall of the cutting chamber of the single machine as described below. After the current single machine completes the slicing operation on the silicon rod, the silicon rod to be processed is still transported from the discharging position corresponding to the single machine to the discharging assembly of the slicing cellular production line according to the control instructions of the group control logic through the cooperation between the ceiling rail robot, the transfer platform corresponding to the discharging area, and the opening and closing assembly corresponding to the discharging area. For multiple production line bodies, the group control logic should consider that the opening and closing assembly shared with other production line bodies can be applied to the transfer operations inside the feeding/discharging area corresponding to this production line body.

It can be seen that in the entire slicing cellular production line of the present disclosure, the functional areas mainly include the feeding area corresponding to the feeding assembly, the slicing areas corresponding to multiple single machines, and the discharging area corresponding to the discharging assembly. Based on this, with the help of the walking of the ceiling rail robot on the ceiling rail and the cooperation between the transfer platforms corresponding to the feeding/discharging areas and the opening and closing assemblies corresponding to the feeding/discharging areas (in a case where the opening and closing assemblies are configured in the feeding/discharging areas), it is possible to achieve the transfer of silicon rods between different single machines as well as between the single machines and the feeding/discharging areas. In addition, by extending the body of the opening and closing assembly (such as the truss), it is expected to achieve the transfer operations inside the feeding/discharging areas for multiple production line bodies through one opening and closing assembly.

In a possible implementation, the production line body is provided with a transition tooling 4, which can be configured on a robotic arm, and silicon rods or wafers containing crystal holders can be carried on the transition tooling. The transition tooling is mainly used to move the silicon rod containing the crystal holder into the cutting area of the single machine through the cooperation with the robotic arm in order to achieve the slice feeding operations for the single machine, or to remove the silicon wafer containing the crystal holder from the cutting area of the single machine through the cooperation with the robotic arm in order to achieve the slice discharging operation for the single machine.

In a possible implementation, the transition tooling 4 includes a tooling base 40 as an installation carrier, as well as a first movable part 41 and a second movable part provided on the tooling base; for example, the robotic arm can cooperate with the tooling base so that the transition tooling is carried on the robotic arm. For example, the tooling base is roughly a plate-like structure. The first movable part can move in a direction of moving in/out from the cutting area of the single machine as mentioned above, thereby driving the silicon rod containing the crystal holder to move in that direction, and the second movable part can form a clamping space to tightly hold the silicon rod containing the crystal holder. In this way, on the basis of tightly holding the silicon rod containing the crystal holder by the second movable part, the feeding and discharging operations of the silicon rod containing the crystal holder for a single machine can be achieved with the help of the first movable part.

In a possible implementation, the first movable part 41 generally includes a strip-shaped structure arranged along the aforementioned direction of moving in/out from the cutting area of the single machine, and a docking structure capable of matching the crystal holder is arranged or formed on the strip-shaped structure along its length direction to achieve a fixed connection between the first movable part and an operating end of the crystal holder through the docking structure. For example, the docking structure is a protruding end 411 extending downward from the strip-shaped structure, which can match a handle serving as an operating end and located at the tail end of the crystal holder to achieve a fixed connection between the first movable part and the crystal holder. In this way, when driven by a servo motor, the strip-shaped structure can freely slide in a groove on the upper surface of the crystal holder. By using the robotic arm to drive the transition tooling to move downward/upward, the protruding end can be matched with the handle at the tail end of the crystal holder to clamp the crystal holder tightly or release the matching, causing the strip-shaped structure to release the crystal holder. In the present disclosure, two protruding ends are provided at approximately two ends of the strip-shaped structure respectively.

For example, the first movable part includes a first servo motor 412, which drives the strip-shaped structure to move along the direction of moving in/out from the cutting area of the single machine through a first screw and nut mechanism 413. In order to ensure more stable movement of the first movable part, a first linear guide rail (not shown) can be arranged on the second movable part along the direction of the first movable part. In this example, a first linear guide rail is arranged on both sides of the strip-shaped structure respectively. Correspondingly, a sliding groove or sliding hole that can cooperate with the linear guide rail is arranged at the end of the strip-shaped structure.

In a possible implementation, the second movable part includes a first part 421 and a second part 422 arranged opposite to each other, and the workpiece is held tightly or released by moving the first part and/or the second part in a direction close to/away from each other. For example, the second movable part is provided with a second servo motor 423, which is connected to a second screw and nut mechanism 424, and the screw of the second screw and nut mechanism includes two threaded segments with opposite screwing directions. The nuts adapted to the two threaded segments with opposite screwing directions are respectively fixed to the first and second parts. In this way, the two parts can be controlled to move close to/away from each other to clamp or release the crystal holder. For example, in order to ensure more stable movement of the two parts close to/away from each other, a second linear guide rial 425 adapted to the second screw and nut mechanism can be configured between the first and second parts.

In a possible implementation, in order to ensure that the two clamping parts can more reliably clamp the silicon rod containing the crystal holder, the first/second parts are formed with clamping structures on the sides close to each other; for example, the first/second parts are formed with vertically arranged clamping plates 426 on the parts close to each other, and multiple protrusions 427 with buffering functions are provided on the clamping plates. In this way, the reliability of clamping can be ensured through multi-point clamping. Of course, the protrusions 427 can also be directly fixed on the first and second parts. In this example, the first/second parts can respectively cooperate with a pair of sides of the crystal holder to tightly hold the silicon rod containing the crystal holder within a clamping space formed by the first and second parts. For example, the clamping plate includes a horizontal part and a vertical part. The clamping plate is located on an inner side of the vertical part, and reinforcement structures such as reinforcing ribs and plates are provided between the horizontal part and the vertical part.

Referring mainly to FIGS. 5 to 9, based on the above structure, after the robotic arm transports the silicon rod (along the length and width directions) in place (FIG. 5), the slice feeding operation process for the cutting chamber of a single machine mainly includes the following steps:

S11: making the ceiling rail robot drive the transition tooling to move downward, so that the protruding end at the tail end of the strip-shaped structure (the right end in FIG. 5) moves downward to hook the handle at the tail end of the crystal holder, thereby achieving the fixed connection between the rear end of the strip-shaped structure and the silicon rod containing the crystal holder.

S12: the first servo motor 412 driving the strip-shaped structure to move (protrude) in the direction toward the cutting chamber, thereby pushing the entire material (the silicon rod containing the crystal holder) out of the interior of the transition tooling and allowing the crystal holder to enter the feeding guide rail of the slicer.

S13: the ceiling rail robot driving the transition tooling to move upward, causing the protruding end at the tail end of the strip-shaped structure to move upward away from the handle at the tail end of the crystal holder; the first servo motor 412 driving the strip-shaped structure to move (retract) in the direction toward the transition tooling, and the ceiling rail robot driving the transition tooling to move downward, causing the protruding end at the front end of the strip-shaped structure to move downward and hook the handle at the tail end of the crystal holder, thereby achieving the fixed connection between the front end of the strip-shaped structure and the silicon rod containing the crystal holder.

S14: the first servo motor 412 driving the strip-shaped structure to move (protrude) in the direction toward the cutting chamber, causing the strip-shaped structure to move (protrude again) in the direction toward the cutting chamber, thereby pushing the entire material into the cutting chamber of the single machine.

S15: the ceiling rail robot driving the transition tooling to move upward, causing the protruding end at the front end of the strip-shaped structure to move upward away from the handle at the tail end of the crystal holder; then the first servo motor 412 driving the strip-shaped structure to move (retract) in the direction toward the transition tooling and into the interior of the transition tooling.

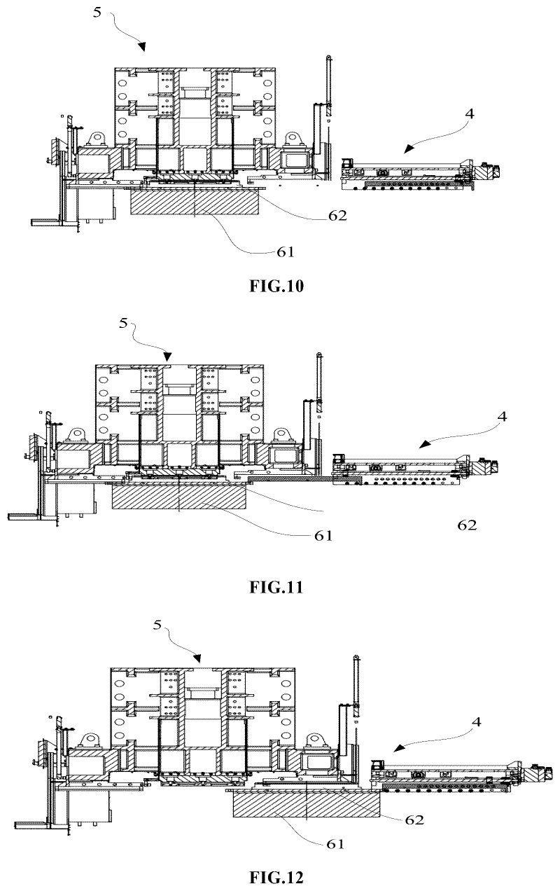

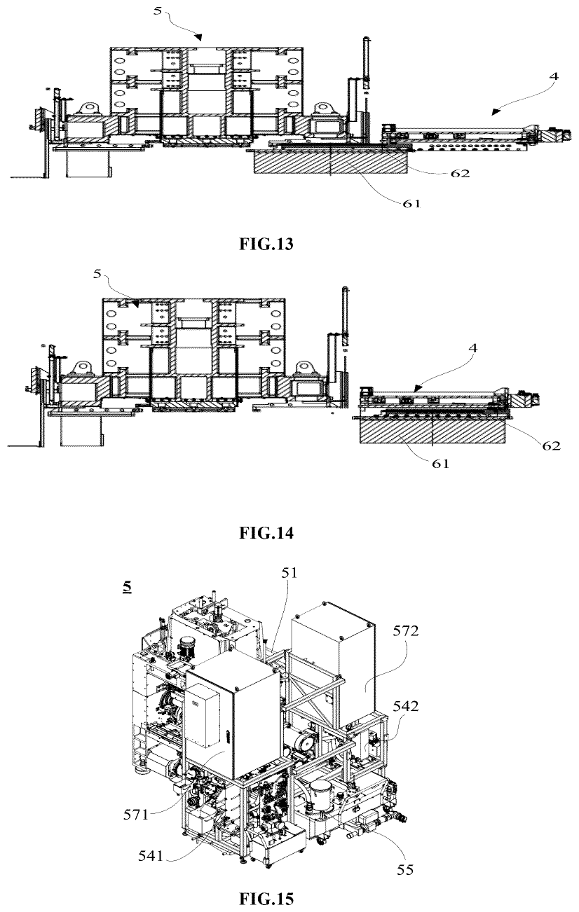

Similarly, still based on the above structure, after the robotic arm transports the silicon rod (along the length and width directions) into place (FIG. 10), the slice discharging operation process for the cutting chamber of a single machine is mainly shown in FIGS. 10 to 14. In the status shown in FIG. 14, the strip-shaped structure moves in the direction away from the cutting chamber (gradually entering the interior of the transition tooling), thereby pulling the entire material (the silicon rod containing the crystal holder) into the space below the transition tooling.

It can be seen that the arrangement of the two protruding ends at the front and tail ends of the strip-shaped structure, combined with its cooperation with the crystal holder and the corresponding movement mode, reliably achieves the feeding and discharging operations for the cutting chamber of a single machine.

In a possible implementation, a rear feeding and discharging port can be provided on a rear wall of the cutting chamber (near the feeding position of the cellular production line), and a rear automatic feeding and discharging door can be provided at a position corresponding to the rear feeding and discharging port. An automatic feeding and discharging auxiliary guide rail can be provided between the crystal holder and the rear automatic feeding and discharging door, and the orientations and structures of the automatic feeding and discharging auxiliary guide rail and the crystal holder can be adapted to each other (such as being roughly flush in height).

In a possible implementation, a front manual feeding and discharging door can be provided on the front wall of the cutting chamber, a manual feeding and discharging auxiliary guide rail can be provided between the front manual feeding and discharging door and the crystal holder, and the orientations and structures of the manual feeding and discharging auxiliary guide rail and the crystal holder can be adapted to each other (such as being roughly flush in height). In this way, with the help of transport device such as a feeding cart, the silicon rods containing crystal holders can be fed onto a front arm through the front manual feeding and discharging door and the manual feeding and discharging auxiliary guide rail, or the silicon wafers containing crystal holders can be discharged after the slicing operation is completed. When the slicer is sold as the smallest unit separately, the front manual feeding and discharging door can be used to achieve the feeding and discharging operations for the slicer that is separated from the scenario of slicing cellular production line. In addition, in the event of feeding failure in the slicing cellular production line, the front feeding and discharging port can also be used to achieve the feeding and discharging operations for the corresponding single slicer.

It can be seen that on one hand, the aforementioned transfer mechanism, feeding/discharging assemblies, and transition tooling can be connected in series with multiple single slicers in the process to achieve cellular and automated slicing operations; on the other hand, the way of manual feeding and discharging can also achieve traditional manual feeding and discharging operations that are separated from the scenario of cellular and automated operations. In this way, the single slicer used as the basic slicing operation unit in the slicing cellular production line to which the present disclosure is applied is expected to be sold in the form of an element of the products that make up the production line, or sold in the form of an independent single machine directly or after acceptable adjustments (such as adjusting the structural forms and configuration orientations of liquid path system, electric control cabinet, liquid supply cylinder and the like to acceptable extents if allowed; for example, based on these adjustments, the constraints set for adapting to the cellular production line scenario can be removed to a certain extent to more friendly adapt to the corresponding single machine application scenario). Therefore, the single slicer used as the basic slicing operation unit in the slicing cellular production line to which the present disclosure is applied can more friendly adapt to different application scenarios according to actual needs, and has good business prospects.

### First embodiment

Referring mainly to FIG. 15, in a possible implementation, in addition to the aforementioned slicer body 51 (including the frame, etc.), the cutting chamber 52, and the cutting mechanism 53 wound with a cutting wire and formed with a cutting wire network, the slicer 5 also includes a liquid path part and an electric control part. The liquid path part includes a liquid path system 54, a liquid supply cylinder 55, and a cutting liquid adding cart (not shown). The electric control part mainly includes an electric control cabinet 57. The main functions of the cutting liquid continuously provided by the liquid path system include cooling, lubrication, and taking away silicon powder and the like generated at the cutting slits during the slicing operation. In this embodiment, the liquid path system includes an internal circulation liquid path unit 541 and an external circulation liquid path unit 542 that are arranged separately. Two electric control cabinets 57 are set according to low and high voltages (referred to as low voltage electric control cabinet 571 and high voltage electric control cabinet 572 respectively), and the liquid supply cylinder that can provide and recover the cutting liquid is provided in a bottom space of the liquid path system.

In order to adapt to the necessary cooperation between the single slicer, the transition tooling, and the transfer mechanism required in the aforementioned slicing cellular production line, in this embodiment, the liquid path system is roughly arranged on a rear side of the cutting chamber, and the internal circulation liquid path unit and the external circulation liquid path unit are placed separately at the rear of the cutting chamber and located on both sides respectively. The low voltage electric control cabinet and the high voltage electric control cabinet are arranged above the internal circulation liquid path unit and the external circulation liquid path unit respectively. In this way, the space between the two electric control cabinets can provide a necessary avoidance space for the feeding operation from the rear end (near the feeding and discharging port of the single slicer) to the front end (near the ceiling rail), thus forming an avoidance space that can ensure the automatic feeding and discharging operations of the single slicer.

The base of the internal circulation liquid path unit is lifted to reserve a space for the liquid supply cylinder, so the liquid supply cylinder can be placed below the internal circulation liquid path unit. Since the weight of the high voltage electric control cabinet is higher than that of the low voltage electric control cabinet, the base of the external circulation liquid path unit is directly placed on the ground. The cutting liquid adding cart can be arranged on a side near the external circulation liquid path unit.

It can be understood that on the premise of ensuring that the single slicer can adapt to the slicing cellular production line, those skilled in the art can flexibly adjust the elements of the single slicer and the relative positions between the elements according to the actual situation. For example, the single slicer can also be constructed in the following ways, including but not limited to the following embodiments.

### Second embodiment

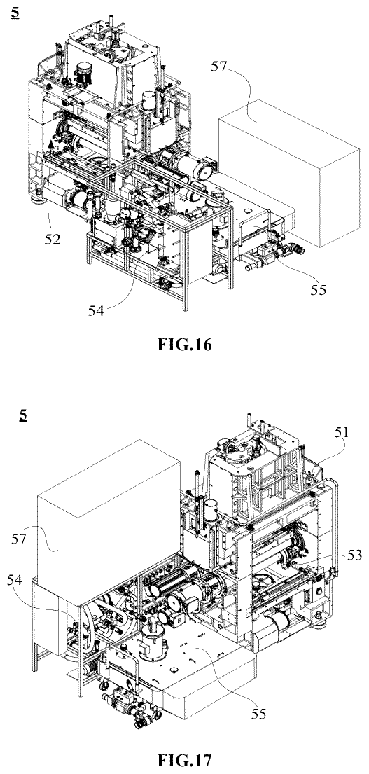

Referring mainly to FIG. 16, unlike the first embodiment, the liquid path system and the electric control cabinet in this embodiment are placed separately at the rear of the cutting chamber and located on both sides respectively, and the liquid supply cylinder is placed between the liquid path system and the electric control cabinet. In this way, the space between the liquid path system and the electric control cabinet forms an avoidance space that can ensure the automatic feeding and discharging operations of the single slicer.

### Third embodiment

Referring mainly to FIG. 17, unlike the second embodiment, the liquid path system and the electric control cabinet in this embodiment are stacked longitudinally on a side at the rear of the cutting chamber of the single slicer; the liquid path system is located below the electric control cabinet, and the liquid supply cylinder is placed on the side of the liquid path system and the electric control cabinet. When viewed in the direction of automatic feeding and discharging, there is no overlap or some overlap with the cutting chamber in space. In this way, due to the low height of the liquid supply cylinder, the configuration of the liquid path system and the electric control cabinet will not interfere, ensuring the formation of the avoidance space that can ensure the automatic feeding and discharging operations of the single slicer.

### Fourth Embodiment

Referring mainly to FIG. 18, unlike the third embodiment, the liquid path system in this embodiment is arranged on a side at the rear of the cutting chamber of the single slicer, and the liquid supply cylinder is placed on the side of the liquid path system. When viewed in the direction of automatic feeding and discharging, there is a certain overlap with the cutting chamber in space. The electric control cabinet is arranged below a relatively far position behind the cutting chamber (including but not limited to: a relatively far position behind the liquid path system and the liquid supply cylinder; a position between two adjacent single slicers). In this way, the overall height of the relevant structures is relatively low, so there is a sufficient avoidance space above the liquid path system, the electric control cabinet and the liquid supply cylinder to ensure the automatic feeding and discharging operations of the single slicer.

It can be seen that in the slicing cellular production line to which the present disclosure is applied, necessary adjustments are made to the traditional single slicers to better adapt to the slicing cellular production line. Based on this, the transition between the silicon rod containing the crystal holder before slicing and the silicon wafer containing the crystal holder after slicing between the feeding assembly and the discharging assembly can be achieved by configuring the transfer mechanism including the ceiling rail robot and the like. By configuring the transition tooling, it is possible to flexibly and smoothly transition the silicon rod before slicing and the monocrystalline silicon rod containing the crystal holder after slicing between the feeding assembly, any single machine, and the discharging assembly, as well as switch them between different single machines. On this basis, by analyzing the feeding and discharging operations of single machines (such as the coordinated control between the transition tooling, the ceiling rail robot, and the crystal holder) and the transfer operation between the single machine and the transfer mechanism (such as the coordinated control between the transfer platforms corresponding to the feeding/discharging areas, the ceiling rail robot, and the opening and closing assemblies corresponding to the feeding/discharging areas), corresponding group control logic can be provided to achieve cellular production of slicing operations. On the basis of achieving cellular slicing operations, it is expected to better meet the market development needs of slice products such as silicon wafers, and better cater to the development trend of the photovoltaic industry.

The slicing cellular production line includes a group control system for processing, which mainly includes the following functional modules.

1) a production task management module: This module is mainly used to implement functions such as issuing, allocating, executing, and completing production tasks. For example, after the administrator issues a production task (including information such as task name, task type, task quantity, etc.), the group control system will allocate the task to an available single machine according to task requirements of the production task, and perform operations such as material retrieving, feeding, slicing, discharging, and releasing through the transfer mechanism. That is, the single machine and transfer mechanism will execute the allocated task according to a pre-set group control logic, and thus ensure that the allocated production task can be completed smoothly. After the completion of production task, the group control system automatically updates the status of production task and device status, providing real-time monitoring of task progress and device status. By way of example:
during the slicing operation of the single machine that completes the current slicing production task, it is judged whether the remaining cutting time of this slicing operation is smaller than a material pre-requesting time of the next production task; if yes, it is allowed to determine the single machine that completes the current slicing production task as the single machine that executes the next production task.

When a retracting signal of the single machine that completes the current slicing production task is detected, the status of the single machine can be adjusted to idling; if yes, it is allowed to determine the single machine that completes the current slicing production task as the single machine that executes the next production task.

2) a storage location management module: This module is mainly used to implement the management of device storage locations, including functions such as adding, deleting, modifying, and querying storage locations. The main purpose is to optimize the storage and management of materials. The administrator can add new storage locations, and specify storage location names/types and other attribute information. On the basis of supporting the deletion and modification of storage locations, it can facilitate the maintenance of storage location information. Optionally, the storage location management module can also provide an interface for the administrator to query storage location information, in order to quickly find specific storage locations.

3) a device management module: This module is mainly used to manage devices (single machines), mainly including functions such as adding, deleting, modifying, and querying devices. In a case of expanding the scale of the slicing cellular production line, the administrator can add new devices (including device name, device type, device location, etc.). Similar to the aforementioned storage location management module, on the basis of supporting deletion and modification of devices, it can facilitate the maintenance and updating of device information. Optionally, the device management module can also provide an interface for the administrator to query device information, in order to find relevant devices according to needs.

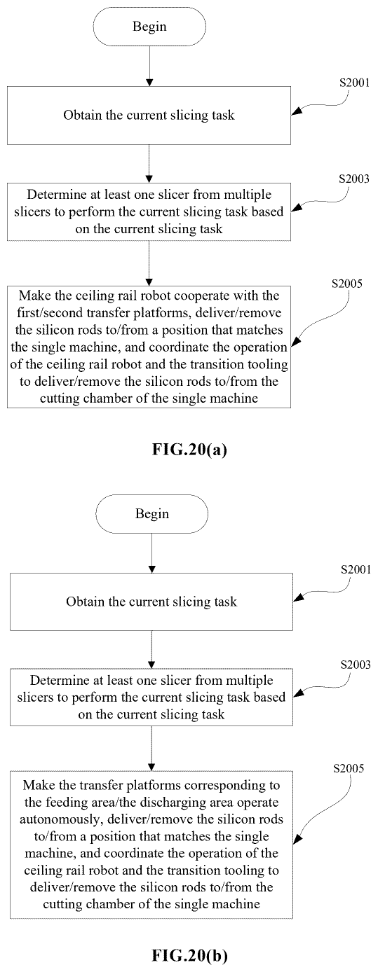

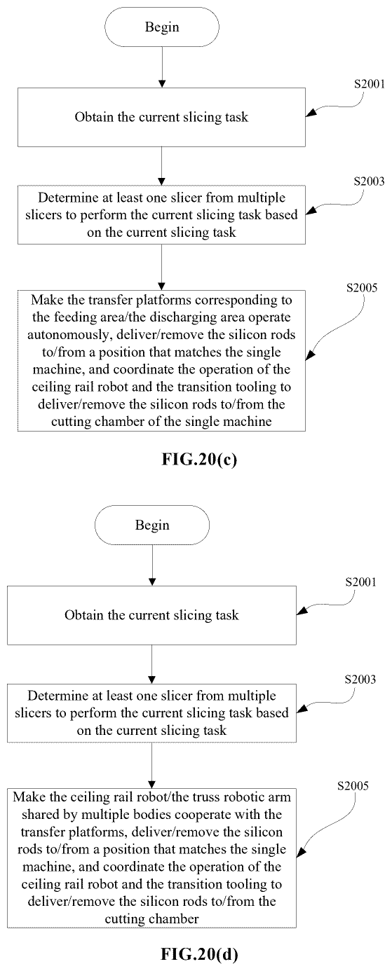

4) a transfer mechanism scheduling module: This module is mainly used to implement task scheduling for the ceiling rail robot, the truss robotic arm, the transfer platform and the like in the transfer mechanism, in order to optimize the efficiency of robot resource utilization. After the group control system allocates a certain production task to a ceiling rail robot that is available within a certain time period based on the device situation, the ceiling rail robot, the truss robotic arm and the transfer platform will complete the corresponding actions of material retrieving, feeding, discharging, and releasing for this task according to a pre-set group control logic. The module also provides real-time progress monitoring of the task. After the current production task is completed, the system automatically updates the task status and can also provide accurate task execution records for viewing. By way of example:
referring mainly to FIG. 20(a), in a possible implementation, the control method for a slicing cellular production line includes the following steps S2001, S2003 and S2005.

S2001: obtaining the current slicing task. The current slicing task can be a slicing operation for one silicon rod or for multiple silicon rods.

S2003: selecting at least one slicer from multiple slicers to perform the current slicing task based on the current slicing task. For example, it is possible to select a single machine that is suitable for the current task from the idle single machines based on the requirements of the task and the device status. For example, the current slicing task is a slicing operation for one silicon rod, and the production task specifies one single machine to perform the slicing operation.

S2005: making the ceiling rail robot drive the first/second transfer platforms to operate, so that workpieces placed on the first/second transfer platforms are delivered to/removed from a position that matches the slicer; and coordinating the operation of the transition tooling and the ceiling rail robot so that the workpieces are delivered to/removed from the cutting area of the slicer. In this example, the task of “delivering/removing silicon rods to/from a position that matches the single machine that performs the current slicing task” is accomplished through the coordinated operation of the ceiling rail robot and the first/second transfer platforms that can move synchronously (non-autonomously) with the ceiling rail robot.

Referring mainly to FIG. 20(b), in a possible implementation, the control method for a slicing cellular production line includes the following steps S2001, S2003 and S2005.

S2001: obtaining the current slicing task. The current slicing task can be a slicing operation for one silicon rod or for multiple silicon rods.

S2003: selecting at least one slicer from multiple slicers to perform the current slicing task based on the current slicing task. For example, it is possible to select a single machine that is suitable for the current task from the idle single machines based on the requirements of the task and the device status. For example, the current slicing task is a slicing operation for one silicon rod, and the production task specifies one single machine to perform the slicing operation.

S2005: making the ceiling rail robot drive the transfer platform arranged in the feeding area/the transfer platform arranged in the discharging area to operate autonomously, so that workpieces placed on the two transfer platforms are delivered to/removed from a position that matches the slicer; and coordinating the operation of the transition tooling and the ceiling rail robot so that the workpieces are delivered to/removed from the cutting area of the slicer. In this example, the task of “delivering/removing silicon rods to/from a position that matches the single machine that performs the current slicing task” is accomplished through the coordinated operation of the ceiling rail robot and the transfer platform corresponding to the feeding area and capable of moving synchronously (non-autonomously) with the ceiling rail robot and the autonomous operation of the transfer platform corresponding to the discharging area and capable of moving autonomously, respectively. Obviously, the task of “removing silicon rods from a position that matches the single machine that performs the current slicing task” can also be accomplished by using the ceiling rail robot to drive the transfer platform corresponding to the discharging area to move synchronously.

Referring mainly to FIG. 20(c), in a possible implementation, the control method for a slicing cellular production line includes the following steps S2001, S2003 and S2005.

S2001: obtaining the current slicing task. The current slicing task can be a slicing operation for one silicon rod or for multiple silicon rods.

S2003: selecting at least one slicer from multiple slicers to perform the current slicing task based on the current slicing task. For example, it is possible to select a single machine that is suitable for the current task from the idle single machines based on the requirements of the task and the device status. For example, the current slicing task is a slicing operation for one silicon rod, and the production task specifies one single machine to perform the slicing operation.

S2005: making the transfer platforms corresponding to the feeding area and the discharging area operate autonomously, so that workpieces placed on the transfer platforms corresponding to the feeding/discharging area are delivered to/removed from a position that matches the slicer; and coordinating the operation of the transition tooling and the ceiling rail robot so that the workpieces are delivered to/removed from the cutting area of the slicer. In this example, the task of “delivering/removing silicon rods to/from a position that matches the single machine that performs the current slicing task” is accomplished through the coordinated operation of the ceiling rail robot and the two transfer platforms that can move independently from the ceiling rail robot (autonomously). Obviously, the corresponding delivering or removing tasks can also be accomplished by making the ceiling rail robot and the transfer platforms move synchronously.

Referring mainly to FIG. 20(d), in a possible implementation, the control method for a slicing cellular production line includes the following steps S2001, S2003 and S2005.

S2001: obtaining the current slicing task. The current slicing task can be a slicing operation for one silicon rod or for multiple silicon rods.

S2003: selecting at least one slicer from multiple slicers to perform the current slicing task based on the current slicing task. For example, it is possible to select a single machine that is suitable for the current task from the idle single machines based on the requirements of the task and the device status. For example, the current slicing task is a slicing operation for one silicon rod, and the production task specifies one single machine to perform the slicing operation.

S2005: making the ceiling rail robot drive the transfer platform corresponding to the feeding area to operate, and coordinating the operation of the truss robotic arm shared by the discharging areas of multiple (such as two) production line bodies and the transfer platform corresponding to the discharging area, so that workpieces placed on the corresponding transfer platforms are delivered to/removed from a position that matches the slicer; and coordinating the operation of the transition tooling and the ceiling rail robot so that the workpieces are delivered to/removed from the cutting area of the slicer. In this example, the task of “delivering silicon rods to a position that matches the single machine that performs the current slicing task” is accomplished through the coordinated operation of the ceiling rail robot and the transfer platforms that can move synchronously (non-autonomously) with the ceiling rail robot. Obviously, it can also be achieved through the autonomous movement of the transfer platform. In addition, the truss robotic arms can also be arranged in both the feeding area and the discharging area. The truss robotic arms can be shared by multiple production line bodies or separately configured for a single production line body.

The control method for a slicing cellular production line to which the present disclosure is applied will be explained below by using an example in which two adjacent single machines are selected to execute the earliest two of the created slicing tasks (Task 1 and Task 2).

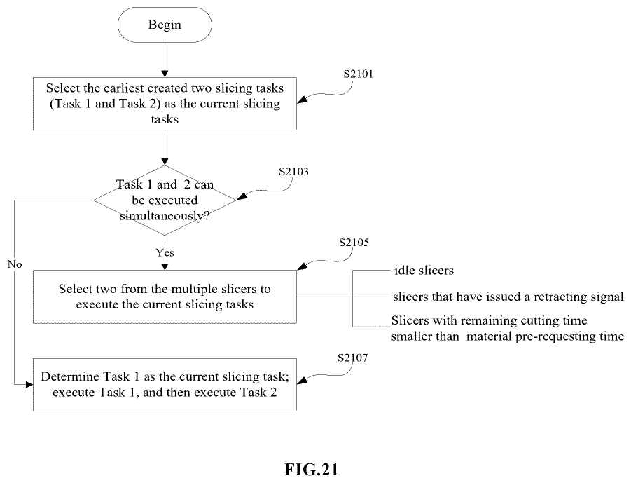

Referring mainly to FIG. 21, in a possible implementation, the control method for a slicing cellular production line mainly includes the following steps S2101, S2103, S2105 and S2107.

S2101: selecting the earliest created two (referred to as Task 1 and Task 2respectively) from the created slicing tasks as the current slicing tasks. Obviously, this is only an exemplary description. Those skilled in the art can choose the construction method of the current slicing tasks according to the actual situation, and determine the specific forms of Task 1 and Task 2 according to the actual situation. For example, the specifications of the silicon rods corresponding to Task 1 and Task 2 can be the same or different, and there may be limitations on the processing of the silicon rods for Task 1 and Task 2 in terms of time period and specified single machine.

S2103: judging whether the slicing cellular production line can meet the conditions for simultaneous execution of Task 1 and Task 2. If yes, the process proceeds to S2105; and if not, the process proceeds to S2107. Based on the current storage location situation of the slicing cellular production line (such as idling, running, and malfunctioning of single machines, as well as the collaborative status of the transfer mechanism), and other constraints and requirements that need to be met when executing Task 1 and Task 2, it can be judged that Task 1 and Task 2 can be executed simultaneously.

S2105: selecting two from the multiple single machines of the slicing cellular production line as the single machines to execute the current slicing tasks. Based on this, the slicing operations for Task 1 and Task 2 are completed through the cooperation between the aforementioned transfer mechanism, transfer platform, and transition tooling. For example, the single machines that can execute the current slicing tasks include an idle and fault-free slicer, a slicer that has issued a retracting signal (which has completed the previous slicing operation and can continue to participate in this slicing operation), and a slicer with a remaining cutting time smaller than a material pre-requesting time (the ongoing slicing operation is close to completion, and when the slicing operation for the current slicing task enters a material pre-requesting preparation stage, the slicer can be scheduled to continue to participate in the slicing operation for the current slicing task). Of course, this is a theoretically feasible status. For example, in a case where there are no additional conditions for Task 1 and Task 2 and the selection logic is random, all the three types of single machines can be selected as the single machines corresponding to the current slicing operation. Obviously, those skilled in the art can add tasks such as Task 1 and Task 2 without any additional conditions or specify specific selection logic based on actual needs. For example, there are limitations on the relative position between two single machines corresponding to Task 1 and Task 2.

S2107: replacing the current execution task with only executing Task 1, adjusting Task 2 to the task to be executed, and completing it at an appropriate time according to the subsequent execution logic. In this example, after changing the current execution task to only executing Task 1, Task 2 is simply adjusted to be executed later. The subsequent execution methods may include but are not limited to: executing Task 2 by the single machine corresponding to Task 1 after completing Task 1; first determining Task 2 can be executed on the premise that there are new tasks that can be executed in the slicing cellular production line; and teaming up Task 2 with other tasks and determining whether they will be executed simultaneously according to the logic described earlier.

It should be pointed out that although the steps are described in a specific order in the above embodiments, it can be understood by those skilled in the art that in order to achieve the effect of the present disclosure, different steps do not necessarily have to be executed in this order. They can be executed simultaneously or in other orders, and some steps can be added, replaced, or omitted. For example, after the single machine that will execute the current slicing task is determined, the device status of the single machine is confirmed again, etc.

It should be noted that although the control method for a slicing cellular production line constructed by the above specific embodiments has been introduced as an example, it can be understood by those skilled in the art that the present disclosure should not be limited to this. In fact, users can flexibly adjust the relevant steps and parameters and other elements in the steps according to the actual application scenario. For example, when Task 1 and Task 2 cannot be executed simultaneously, the current execution task can be replaced with Task 1 and Task 3, and the judgment of whether Task 1 and Task 3 can be executed simultaneously is continued, etc.

Hitherto, the technical solutions of the present disclosure have been described in connection with the preferred embodiments shown in the accompanying drawings, but it is easily understood by those skilled in the art that the scope of protection of the present disclosure is obviously not limited to these specific embodiments. Without deviating from the principle of the present disclosure, those skilled in the art can make equivalent changes or replacements to relevant technical features, and all the technical solutions after these changes or replacements will fall within the scope of protection of the present disclosure.

1. A slicer, characterized in that the slicer comprises: a slicer body formed with a cutting chamber; a liquid path part; and an electric control part; wherein the liquid path part and the electric control part are configured on the outside of the cutting chamber, and the liquid path part and the electric control part are configured such that the slicer creates an avoidance space, so that workpieces can be fed and/or discharged through the avoidance space.

2. The slicer according to claim 1, wherein the electric control part comprises a first electric control cabinet and a second electric control cabinet, which are arranged concentratedly or separately, and the liquid path part comprises a liquid supply cylinder and a liquid path system; the liquid path system comprises a first liquid path unit and a second liquid path unit, which are arranged concentratedly or separately; preferably, the first liquid path unit and the second liquid path unit are separately arranged on both sides of the cutting chamber, and the first electric control cabinet and the second electric control cabinet are respectively arranged above the first liquid path unit and the second liquid path unit, so that the avoidance space is formed between the first electric control cabinet and the second electric control cabinet; preferably, a reserved space is formed below the first liquid path unit, and the liquid supply cylinder is arranged in the reserved space; preferably, the first liquid path unit and the second liquid path unit are concentratedly arranged to form a first assembly, and the first electric control cabinet and the second electric control cabinet are concentratedly arranged to form a second assembly; the first assembly and the second assembly are separately arranged on both sides of the cutting chamber so that the avoidance space is formed between them; preferably, the liquid supply cylinder is arranged between the second assembly and the second assembly; preferably, the first liquid path unit and the second liquid path unit are concentratedly arranged to form a first assembly, and the first electric control cabinet and the second electric control cabinet are concentratedly arranged to form a second assembly; the first assembly and the second assembly are arranged on one side of the cutting chamber along a feeding and discharging direction of workpiece by being longitudinally stacked, so that the avoidance space that is open is formed between the cutting chamber and said one side; preferably, the liquid supply cylinder is arranged on the side of a structure formed by the longitudinal stacking of the first assembly and the second assembly, and is projected toward the cutting chamber along the feeding and discharging direction of workpiece; the cutting chamber and the liquid supply cylinder at least partially overlap with each other; preferably, the first liquid path unit and the second liquid path unit are concentratedly arranged to form a first assembly, and the first electric control cabinet and the second electric control cabinet are concentratedly arranged to form a second assembly; the first assembly is arranged on one side of the cutting chamber along the feeding and discharging direction of workpiece, and the second assembly and/or the liquid supply cylinder are configured in a movable manner to the cutting chamber, so that the avoidance space that is open is formed above the first assembly.

3. A slicing cellular production line, characterized in that the production line comprises: at least one production line body; at least one slicer according to claim which is configured on the production line body; and a transfer mechanism, which is capable of carrying workpieces and at least capable of delivering/removing the workpieces to/from the slicer through the avoidance space, wherein the transfer mechanism comprises one or more of ceiling rail robot, ground rail robot, truss robotic arm, AGV, RGV, and opening and closing assembly; preferably, the transfer mechanism comprises at least one ceiling rail robot, which is at least capable of carrying the workpieces and delivering and/or removing them to/from the slicer through the avoidance space.

4. The slicing cellular production line according to claim 3, wherein the production line body is provided with a feeding assembly and a discharging assembly, and the transfer mechanism can move between a feeding area corresponding to the feeding assembly and a discharging area corresponding to the discharging assembly; and/or the transfer mechanism can move within the feeding area and/or the discharging area.

5. The slicing cellular production line according to claim 4, wherein the transfer mechanism can move close to/away from the slicer at a certain position between the feeding area and the discharging area; and/or the transfer mechanism can move close to/away from the slicer in a vertical direction.

6. The slicing cellular production line according to claim 3, wherein the production line body is provided with a transition tooling, which can be arranged on the transfer mechanism, and the workpieces can be carried onto the transition tooling; the transition tooling comprises: a first movable part, which can move in a direction close to/away from the cutting chamber of the slicer, and which is provided with at least one docking structure that can fix the first movable part to the workpieces; a carrying part, which can carry the workpieces, so that when the workpieces are carried on the carrying part, the carrying part and the workpieces move along with the movement of the first movable part; preferably, the carrying part comprises a second movable part, which comprises a first part and a second part, between which a relative movement can be generated in a direction of moving close to/away from each other to tightly hold the workpieces; and a tooling base, on which the first movable part is arranged.

7. The slicing cellular production line according to claim 6, wherein the workpiece is carried on a crystal holder, and the docking structure can be matched with the crystal holder to achieve a fixed connection between the workpiece and the first movable part; the crystal holder comprises an operating end, and the docking structure can be fixedly connected to the crystal holder by extending into the operating end; preferably, the first movable part is a strip-shaped structure, which is provided with multiple docking structures along its length direction; the strip-shaped structure has a first end and a second end; the strip-shaped structure is provided with the docking structure at the first end or at a position near the first end, and the strip-shaped structure is provided with the docking structure at the second end or at a position near the second end.

8. The slicing cellular production line according to claim 7, wherein the transition tooling comprises: a first driving component, which is capable of driving the first movable part to move in a direction close to/away from the cutting chamber; preferably, the first driving component drives the first movable part to move close to/away from the cutting chamber through the first screw and nut mechanism; and a second driving component, which is capable of driving the first part and/or the second part to move; preferably, the screw of the second screw and nut mechanism has two threaded segments with opposite screwing directions, and the second driving component can drive the first part and the second part to move close to/away from each other through the second screw and nut mechanism.

9. The slicing cellular production line according to claim 1, wherein the transfer mechanism comprises: a feeding transfer mechanism, which is capable of at least transferring the workpieces in the feeding area close to/away from the slicer; and/or a discharging transfer mechanism, which is capable of at least transferring the workpieces in the discharging area close to/away from the slicer; preferably, the production line body is provided with a transfer platform, and the ceiling rail robot can deliver/remove the workpieces to/from the transfer platform; and/or the feeding transfer mechanism and/or the discharging transfer mechanism can deliver/remove the workpieces to/from the transfer platform; preferably, the transfer platform can be arranged in the feeding area and/or the discharging area; preferably, the transfer platform is arranged in a movable manner on the production line body; preferably, the feeding transfer mechanism and/or the discharging transfer mechanism comprise an opening and closing assembly, which can clamp and transfer the workpieces; preferably, the feeding transfer mechanism and/or the discharging transfer mechanism comprise a frame, and the opening and closing assembly can move along the frame;
in a case where there are multiple production line bodies, the opening and closing assembly can switch between different production line bodies through its movement along the frame.

10. A control method for the slicing cellular production line according to claim 3, characterized in that the slicing cellular production line comprises a production line body, which comprises a transfer mechanism and multiple slicers, and the control method comprises: obtaining the current slicing task; selecting at least one slicer from the multiple slicers to perform the current slicing task, based on the current slicing task; and
at least operating the transfer mechanism to deliver/remove the workpieces to/from a position that matches the at least one slicer; wherein the transfer mechanism comprises one or more of ceiling rail robot, ground rail robot, truss robotic arm, AGV, RGV, and opening and closing assembly;
preferably, the production line body is provided with a feeding assembly and a discharging assembly, and comprises a transfer mechanism, a transition tooling, and multiple slicers;
the transfer mechanism comprises a ceiling rail robot, a first transfer platform configured in a feeding area corresponding to the feeding assembly, and a second transfer platform configured in a discharging area corresponding to the discharging assembly; the ceiling rail robot is capable of moving between the feeding area corresponding to the feeding assembly and the discharging area corresponding to the discharging assembly, as well as within the feeding area and/or the discharging area; correspondingly, the control method comprises: obtaining the current slicing task;
selecting at least one slicer from the multiple slicers to perform the current slicing task, based on the current slicing task; making the ceiling rail robot drive the first transfer platform and/or the second transfer platform to operate, so as to deliver/remove the workpieces placed on the first transfer platform and/or the second transfer platform to/from a position that matches the at least one slicer; and coordinating the operation of the transition tooling and the ceiling rail robot to deliver/remove the workpieces to/from a cutting area of the slicer; or the transfer mechanism comprises a ceiling rail robot, a truss robotic arm, and two transfer platforms respectively configured in a feeding area corresponding to the feeding assembly and a discharging area corresponding to the discharging assembly; one of the feeding area and the discharging area is provided with the truss robotic arm that can move within the corresponding feeding area or discharging area; the ceiling rail robot can move between the feeding area corresponding to the feeding assembly and the discharging area corresponding to the discharging assembly, and can move within the feeding area or discharging area which is not provided with the truss robotic arm; correspondingly, the control method comprises: obtaining the current slicing task; selecting at least one slicer from the multiple slicers to perform the current slicing task, based on the current slicing task; making the ceiling rail robot drive the transfer platform in the feeding area or the discharging area which is not provided with the truss robotic arm to operate and/or coordinating the operation of the truss robotic arm and the transfer platform in the feeding area or the discharging area which is provided with the truss robotic arm, so as to deliver/remove the workpieces placed on the corresponding transfer platform to/from a position that matches the at least one slicer; and coordinating the operation of the transition tooling and the ceiling rail robot to deliver/remove the workpieces to/from the cutting area of the slicer; or the transfer mechanism comprises a ceiling rail robot, two transfer platforms and two truss robotic arms respectively configured in a feeding area corresponding to the feeding assembly and a discharging area corresponding to the discharging assembly; the ceiling rail robot can move between the feeding area corresponding to the feeding assembly and the discharging area corresponding to the discharging assembly, and the truss robotic arms can move within the corresponding feeding area or discharging area; correspondingly, the control method comprises:
obtaining the current slicing task; selecting at least one slicer from the multiple slicers to perform the current slicing task, based on the current slicing task; operating the ceiling rail robot and/or operating the transfer platform corresponding to the feeding area or the discharging area and/or coordinating the operation of the truss robotic arm and the corresponding transfer platform in the feeding area or the discharging area, so as to deliver/remove the workpieces placed on the corresponding transfer platform to/from a position that matches the at least one slicer; and
coordinating the operation of the transition tooling and the ceiling rail robot to deliver/remove the workpieces to/from the cutting area of the slicer; or the transfer mechanism comprises a ceiling rail robot, two transfer platforms respectively configured in a feeding area corresponding to the feeding assembly and a discharging area corresponding to the discharging assembly, and truss robotic arms configured in the feeding area and/or the discharging area; the ceiling rail robot can move between the feeding area corresponding to the feeding assembly and the discharging area corresponding to the discharging assembly, and can move within the feeding area or the discharging area which is not provided with the truss robotic arm; at least one of the truss robotic arms configured in the feeding area and/or the discharging area can move between at least two of the multiple production line bodies;
correspondingly, the control method comprises: obtaining the current slicing task; selecting at least one slicer from the multiple slicers to perform the current slicing task, based on the current slicing task; making the ceiling rail robot drive the transfer platform in the feeding area or the discharging area which is not provided with the truss robotic arm to operate; and/or coordinating the operation of the truss robotic arm and the transfer platform in the feeding area and/or the discharging area which is provided with the truss robotic arm; and/or moving the truss robotic arm between at least two of the multiple production line bodies, so as to deliver/remove the workpieces placed on the corresponding transfer platform to/from a position that matches the at least one slicer; and
coordinating the operation of the transition tooling and the ceiling rail robot to deliver/remove the workpieces to/from the cutting area of the slicer.

11. The control method according to claim 10, wherein the “selecting at least one slicer from the multiple slicers to perform the current slicing task based on the current slicing task” comprises: selecting multiple created slicing tasks as the current slicing tasks; judging whether the multiple created slicing tasks can be performed simultaneously; and if yes, determining multiple slicers from the multiple slicers to perform the current slicing tasks.

12. The control method according to claim 11, wherein the “judging whether the multiple created slicing tasks can be performed simultaneously” comprises: if not, re-selecting the current slicing task or taking at least one of the selected multiple created slicing tasks as the current slicing task; and determining a slicer from the multiple slicers to perform the current slicing task.

13. The control method according to claim 12, wherein the “determining a slicer from the multiple slicers to perform the current slicing task” comprises: during the slicing operation of the slicer, judging whether the remaining cutting time is smaller than a material pre-requesting time; and if yes, allowing the slicer to be determined as the slicer to perform the current slicing task.

14. The control method according to claim 11, wherein the “determining a slicer from the multiple slicers to perform the current slicing task” comprises: during the slicing operation of the slicer, judging whether the slicer has issued a retracting signal; and if yes, allowing the slicer to be determined as the slicer to perform the current slicing task.

15. The control method according to claim 10, wherein the transition tooling comprises a first movable part, and at least one docking structure is provided on the first movable part; and the “coordinating the operation of the transition tooling and the ceiling rail robot to deliver/remove the workpieces to/from the cutting area of the slicer” comprises: fixing the docking structure to the workpieces, and moving the first movable part in a direction close to/away from the cutting chamber of the slicer, so as to deliver/remove the workpieces to/from the cutting area of the slicer.

16. The control method according to claim 10, wherein the slicer is capable of creating an avoidance space, and workpieces located at a position that matches the at least one slicer can be fed and/or discharged for the cutting area of the slicer through the avoidance space.

17. The control method according to claim 10, wherein the “making the ceiling rail robot drive the first transfer platform and/or the second transfer platform to operate, so as to deliver/remove the workpieces placed on the first transfer platform and/or the second transfer platform to/from a position that matches the at least one slicer” comprises: making the ceiling rail robot drive the first transfer platform and/or the second transfer platform to operate, so that before performing the slicing operation on the workpieces, the workpieces are delivered from the feeding area corresponding to the feeding assembly to the position that matches the at least one slicer;
and/or after performing the slicing operation on the workpieces, the workpieces are removed from the position that matches the at least one slicer to the discharging area corresponding to the discharging assembly;
preferably, before the step of “before performing the slicing operation on the workpieces, the workpieces are delivered from the feeding area corresponding to the feeding assembly to the position that matches the at least one slicer”, the control method comprises: operating the ceiling rail robot within the feeding area to transfer the workpieces from the feeding assembly to the first transfer platform in the feeding area; and
preferably, after the step of “after performing the slicing operation on the workpieces, the workpieces are removed from the position that matches the at least one slicer to the discharging area corresponding to the discharging assembly”, the control method comprises: at least moving the transfer mechanism within the discharge area to transfer the workpieces from the second transfer platform in the discharge area to the discharge assembly.

18. The control method according to claim 10, wherein the “making the ceiling rail robot drive the transfer platform in the feeding area or the discharging area which is not provided with the truss robotic arm to operate and/or coordinating the operation of the truss robotic arm and the transfer platform in the feeding area or the discharging area which is provided with the truss robotic arm, so as to deliver/remove the workpieces placed on the corresponding transfer platform to/from a position that matches the at least one slicer” comprises: making the ceiling rail robot drive the transfer platform in the feeding area or the discharging area which is not provided with the truss robotic arm to operate, so that before performing the slicing operation on the workpieces, the workpieces are delivered from the feeding area corresponding to the feeding assembly to the position that matches the at least one slicer; and/or after performing the slicing operation on the workpieces, the workpieces are removed from the position that matches the at least one slicer to the discharging area corresponding to the discharging assembly;
preferably, before the step of “before performing the slicing operation on the workpieces, the workpieces are delivered from the feeding area corresponding to the feeding assembly to the position that matches the at least one slicer”, the control method comprises: at least moving the ceiling rail robot within the feeding area if the feeding area is not provided with the truss robotic arm, and at least moving the truss robot arm within the feeding area if the feeding area is provided with the truss robotic arm, so as to transfer the workpieces from the feeding assembly to the first transfer platform in the feeding area; and
preferably, after the step of “after performing the slicing operation on the workpieces, the workpieces are removed from the position that matches the at least one slicer to the discharging area corresponding to the discharging assembly”, the control method comprises: at least moving the ceiling rail robot within the discharging area if the discharging area is not provided with the truss robotic arm, and at least moving the truss robot arm within the discharging area if the discharging area is provided with the truss robotic arm, so as to transfer the workpieces from the second transfer platform in the discharging area to the discharging assembly.

19. The control method according to claim 10, wherein the step of “operating the ceiling rail robot and/or operating the transfer platform corresponding to the feeding area or the discharging area and/or coordinating the operation of the truss robotic arm and the corresponding transfer platform in the feeding area or the discharging area, so as to deliver/remove the workpieces placed on the corresponding transfer platform to/from a position that matches the at least one slicer” comprises: operating the transfer platform corresponding to the feeding area or the discharging area, or making the ceiling rail robot drive the transfer platform corresponding to the feeding area or the discharging area to operate, so that before performing the slicing operation on the workpieces, the workpieces are delivered from the feeding area corresponding to the feeding assembly to the position that matches the at least one slicer; and/or after performing the slicing operation on the workpieces, the workpieces are removed from the position that matches the at least one slicer to the discharging area corresponding to the discharging assembly;
preferably, before the step of “before performing the slicing operation on the workpieces, the workpieces are delivered from the feeding area corresponding to the feeding assembly to the position that matches the at least one slicer”, the control method comprises: coordinating the operation of the transfer platform corresponding to the feeding area and the truss robotic arm to transfer the workpieces from the feeding assembly to the transfer platform in the feeding area; and
preferably, after the step of “after performing the slicing operation on the workpieces, the workpieces are removed from the position that matches the at least one slicer to the discharging area corresponding to the discharging assembly”, the control method comprises: coordinating the operation of the transfer platform corresponding to the discharging area and the truss robotic arm to transfer the workpieces from the transfer platform in the discharging area to the discharging assembly.

20. The control method according to claim 10, wherein the step of “making the ceiling rail robot drive the transfer platform in the feeding area or the discharging area which is not provided with the truss robotic arm to operate; and/or coordinating the operation of the truss robotic arm and the transfer platform in the feeding area and/or the discharging area which is provided with the truss robotic arm; and/or moving the truss robotic arm between at least two of the multiple production line bodies, so as to deliver/remove the workpieces placed on the corresponding transfer platform to/from a position that matches the at least one slicer” comprises:
operating the transfer platform corresponding to the feeding area or making the ceiling rail robot drive the transfer platform corresponding to the feeding area to operate, so that before performing the slicing operation on the workpieces, the workpieces are delivered from the feeding area corresponding to the feeding assembly to the position that matches the at least one slicer; and/or after performing the slicing operation on the workpieces, the workpieces are removed from the position that matches the at least one slicer to the discharging area corresponding to the discharging assembly;
preferably, before the step of “before performing the slicing operation on the workpieces, the workpieces are delivered from the feeding area corresponding to the feeding assembly to the position that matches the at least one slicer”, the control method comprises: moving the ceiling rail robot within the feeding area, or coordinating the operation of the truss robotic arm and the transfer platform corresponding to the feeding area, so as to transfer the workpieces from the feeding assembly to the transfer platform in the feeding area; wherein the truss robotic arm is capable of moving between at least two of the multiple production line bodies; and
preferably, after the step of “after performing the slicing operation on the workpieces, the workpieces are removed from the position that matches the at least one slicer to the discharging area corresponding to the discharging assembly”, the control method comprises: moving the ceiling rail robot within the feeding area, or coordinating the operation of the truss robotic arm and the transfer platform corresponding to the feeding area, so as to transfer the workpieces from the transfer platform in the discharging area to the discharging assembly; wherein the truss robotic arm is capable of moving between at least two of the multiple production line bodies.
